(19) United States
(12) Patent Application Publication
(10) Pub. No.: US 2017/0305477 A1
(43) Pub. Date: Oct. 26, 2017

(54) DAMPING FLUID DEVICES, SYSTEMS, AND METHODS

(71) Applicant: LORD Corporation, Cary, NC (US)

(72) Inventors: Scott K. THOMPSON, Asheville, NC (US); Nick C. MCELDOWNEY, Lake City, PA (US); James A. MACIAK, Erie, PA (US)

(21) Appl. No.: 15/518,159

(22) PCT Filed: Oct. 24, 2014
(86) PCT No.: PCT/US2014/062093

§ 371 Date: Apr. 10, 2017

(51) Int. Cl. B62D 33/06; F16F 13/08; B62D 33/10; F16F 13/10; B62D 65/02

(52) U.S. Cl. CPC B62D 33/0608; F16F 13/103; B62D 65/024; B62D 33/10; F16F 13/085; F16F 2224/04; F16F 2230/00

(57) ABSTRACT

The present subject matter relates to improved damping fluid mount devices, systems, and methods in which a damping fluid mount (100) includes an inner member (110), an elastomer section (130) that is affixed to an outer surface of the inner member (110), an annular damping plate (140) attached to a bottom portion of the inner member (110), a cup (200) containing viscous fluid positioned about the elastomer section and the damper plate, and a collar (310) positioned about a portion of the elastomer section (130), the collar (310) having an inner diameter that is less than an outer diameter of the damper plate (140).

### TECHNICAL FIELD

The subject matter disclosed herein relates to devices, systems, and methods for reducing and controlling gross vehicle cab vibrations. More particularly, the subject matter disclosed herein relates to devices, systems and methods for reducing and controlling movement in off-highway cabs, particularly for reducing vibration and increasing high-frequency isolation in off-highway cabs.

### BACKGROUND

Gross off-highway cab movement and vibration are particularly troublesome in that they can cause fatigue and wear on equipment. In cabs of industrial vehicles or construction equipment, vibrations are particularly problematic in that they create multiple fatigue and wear points. In addition to the fatigue and wear on the equipment, the same movement and vibration causes fatigue to the operator and interferes with the operator's ability to operate the equipment.

In contrast to narrowband damping, which provides for a narrow vibrational band and/or only provides damping at either low or high vibrational frequencies, broadband damping provides damping across a large spectrum of vibrational frequencies. Broadband damping is usually achieved by using annular damping and a relatively high viscosity fluid, which results in damping across a wide range of frequencies.

There is a need for an improved device that reduces gross vibration and movement in off-highway vehicle cabs, yet is durable and/or can be manufactured in a cost-effective manner.

### SUMMARY

In accordance with this disclosure, improved damping fluid mount devices, systems and methods are provided, for example with a damping fluid mount and a method or process for assembling a fluid mount easily adaptable to different static load and damping fluid mount configurations.

In one aspect, the present subject matter provides a damping fluid mount, which includes an inner member, an elastomer section that is affixed to an outer surface of the inner member, an annular damping plate attached to a bottom portion of the inner member, a cup containing viscous fluid positioned about the elastomer section and the damper plate, and a collar positioned about a portion of the elastomer section, the collar having an inner diameter that is less than an outer diameter of the damper plate.

In another aspect, a damping fluid mount includes an inner member, an elastomer section that is affixed to an outer surface of the inner member, an annular damping plate attached to a bottom portion of the inner member, a cup containing viscous fluid positioned about the elastomer section and the damper plate, and a collar positioned about the portion of the cup that is crimped. In this configuration, however, a portion of the cup is radially crimped into a precompressed portion of the elastomer section, an inner diameter of the portion of the cup that is crimped being less than an outer diameter of the annular damping plate, and the collar having an inner diameter that is less than the outer diameter of the damper plate.

In yet another aspect, a method for assembling a damping fluid mount is provided. The method includes coupling an elastomer section to an outer surface of an inner member, coupling a damping plate to a bottom portion of the inner member, inserting the elastomer section coupled to the inner member and to the damping plate into a cup, wherein the cup contains a quantity of viscous fluid, and positioning a collar about a portion of the elastomer section, the collar having an inner diameter that is less than an outer diameter of the damper plate.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

FIG. 1 is a cutaway perspective view of a damping fluid mount according to an embodiment of the presently disclosed subject matter.

FIG. 2 is a cutaway perspective view of a damping fluid mount according to an alternative embodiment of the presently disclosed subject matter.

FIGS. 3-6 are sectional views showing in detail a method of assembling a damping fluid mount according to an embodiment of the presently disclosed subject matter.

### DETAILED DESCRIPTION

The present subject matter provides improvement to vibration damping fluid mounts for use in off-highway vehicle cabs, particularly those incorporating a roll-over protection structure (ROPS). The disclosed devices and methods manufacture a damping fluid mount that creates an overlap between the damping plate held within the fluid mount and a ROPS support collar that is provided to carry the required ROPS loading. In some embodiments, this interleaved ROPS support collar is provided in combination with a crimped cup design that pre-compresses the elastomer section of the fluid mount, which provides a fluid mount with superior sealing, improved fatigue life, increased durability and improved high-frequency isolation.

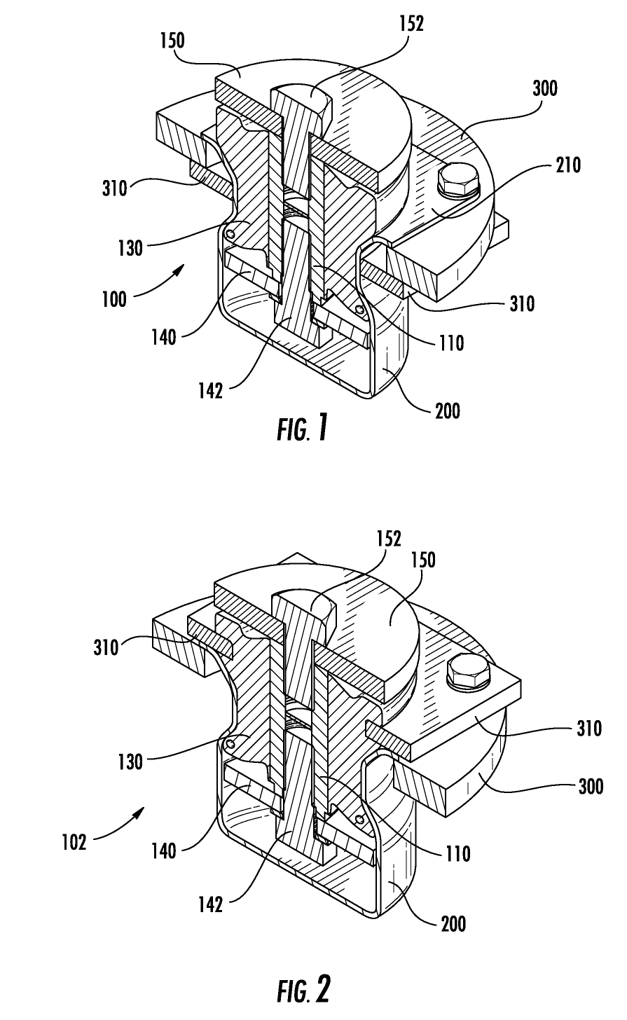

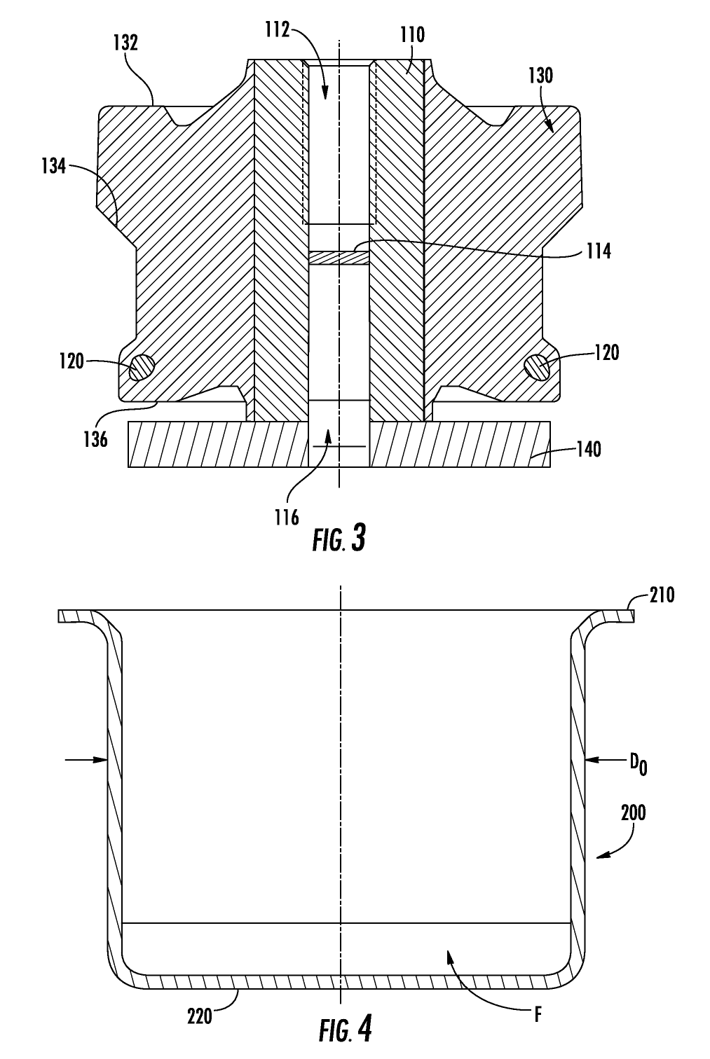

In one exemplary configuration shown in FIG. 1, for example, the present subject matter provides a broadband damping fluid mount, generally designated 100, contained by an outer cup 200. Similarly, FIG. 2 illustrates an alternative configuration for a broadband damping fluid mount, generally designated 102. In either configuration, the broadband damping fluid mount 100 or 102 comprises a bonded core that includes an inner member 110 and an elastomer section 130, where an inner surface of the elastomer section 130 is coupled (e.g. bonded, adhered, friction fit, etc.) to an outer surface of the inner member 110 as shown in FIG. 3. In some embodiments, this bonded core is manufactured by providing the inner member 110 with proper surface preparation and adhesive applied, and adding the inner member 110 into a mold. Proper surface preparation is known those skilled in the relevant art. The mold is closed, and elastomer material is injected into the cavity and cured, thus curing the elastomer and adhesive.

As further illustrated in FIG. 3, a damping plate 140 is attached at a bottom portion of the inner member 110. For example, in the embodiments illustrated in FIGS. 1 and 2, the damping plate 140 is attached to a bottom portion of the inner member 110 by a damping plate fastener 142 (e.g., a bolt). In particular, as shown in FIG. 3, the inner member 110 includes a lower blind threaded hole 116 into which the damping plate fastener 142 can be inserted and secured in place after positioning the damping plate 140 against the bottom portion of the inner member 110. Alternatively, those having skill in the art will appreciate that other similar approaches and structures in which the damping plate 140 is fixedly attached to the inner member 110 can be sufficient. The thickness of the damping plate 140 is selected to handle the rated ROPS load, and the materials of the inner member 110, the damping plate 140, and the damping plate fastener 142 are selected to meet the necessary mechanical and charpy impact resistance for ROPS compliance. For example, the design of these elements are able to be optimized for the largest 1G static load rating for a given application (e.g., for a 250 kg mount) while still being able to achieve mounts with a 1G load rating in lower loading configurations (e.g., as low as 100 kg or less) by simply changing the modulus of the elastomer used to form the elastomer section 130. This allows an entire range of mounts to be manufactured by only altering the rubber modulus used to form the bonded unit.

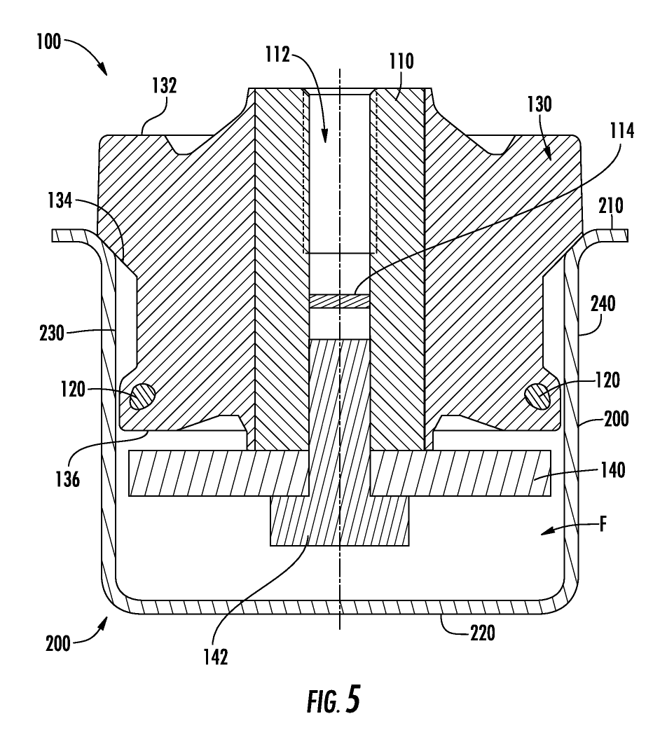

As indicated above, the assembled combination of the inner member 110, the elastomer section 130, and the damping plate 140 are contained within an outer cup 200, an example of which is illustrated in FIG. 4. In the configuration shown in FIG. 4, the outer cup 200 has a substantially cylindrical shape having an original cup diameter D₀ that extends between an open upper portion on which a flange 210 is formed and a closed bottom 220. As shown in FIG. 5, a portion of the bonded core that includes the inner member 110, the elastomer section 130, and the damper plate 140 is snuggly contained within the outer cup 200. In some embodiments, a remaining portion of the inner member 110 and the elastomer section 130 extend out of the outer cup 200 above the flange 210.

In any configuration, the outer cup 200 additionally contains a quantity of viscous fluid F, which provides damping in the fluid mounts 100 and 102. For example, when the bonded core is placed within outer cup 200, the quantity of fluid F is disposed beneath damping plate 140. Thus, the quantity of viscous fluid F and the damping plate 140 act as a dashpot damper by allowing fluid flow around an outer diameter of the damping plate 140 (i.e. annular damping). Where holes (not shown) are included in the damping plate 140, the damping plate 140 further exhibits orifice damping as the quantity of viscous fluid F flows through the holes in the damping plate 140. In this case, the dashpot damper dissipates the overall energy of the system and creates softer mount stiffness for equivalent motion control. In some embodiments, air is present on both sides of the damping plate 140 (i.e., above the damping plate 140, but below a bottom of the elastomer section 130, and below the damping plate 140 in the portion of the outer cup 200 in which the viscous fluid F is provided).

However, increasing the overall damping of a system can result in increased dynamic stiffness. Therefore, in order to increase overall system damping and maintain isolation, a low-amplitude decoupler can be used to reduce the damping at low-amplitude, high frequency input. One means of achieving decoupling is to have the bottom 220 of the outer cup 200 be a substantially flat surface. The flat surface provides decreased volume stiffness for the quantity of viscous fluid F disposed below the damping plate 140, thereby providing improved high-frequency isolation. Alternatively or in addition, the volume of the viscous fluid F is selected so that a certain percentage of air is present in the fluid cavity to allow deflection even at frequencies at which the damping fluid F may get very stiff (such as at the annular and/or orifice damping interfaces).

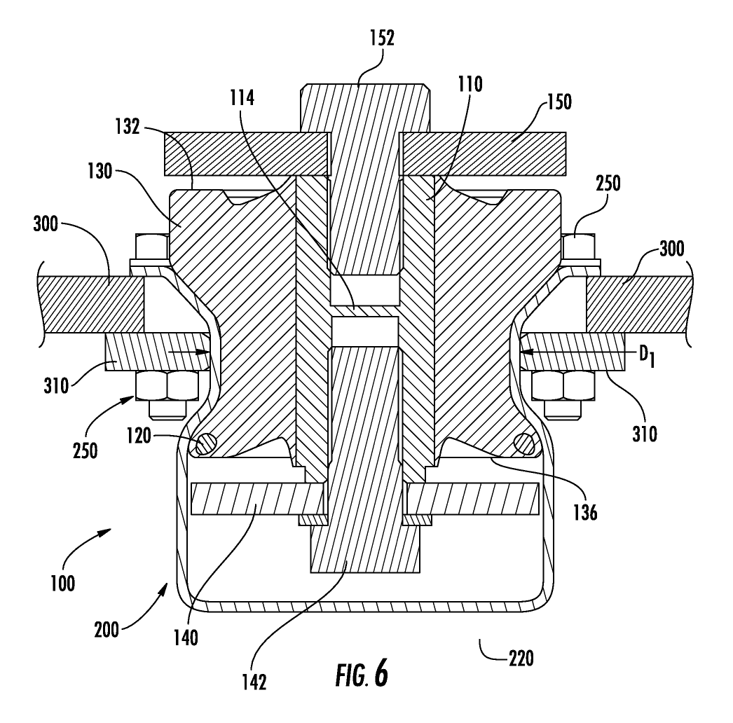

The outer cup 200 is further coupled to a supporting frame structure 300, such as a vehicle frame of an off-highway vehicle. In the embodiment shown in FIG. 1, for example, a collar 310 is secured to the flange 210 (e.g., by a bolted connection 250 shown in FIG. 6), and the collar 310 connects the outer cup 200 to the supporting frame structure 300. In the particular configuration shown in FIG. 1, for example, the collar 310 is positioned about the elastomer section 130 below the flange 210. Alternatively, in the further exemplary configuration shown in FIG. 2, the broadband damping fluid mount 102 has the collar 310 positioned about the elastomer section 130 above the flange 210. In some embodiments, the collar 310 includes two substantially semi-circular collar elements that are positioned on either side of the elastomer section 130. In any configuration, the collar 310 is sized to have an inner diameter that is less than an outer diameter of the damper plate 140. In this way, even if elastomeric failure of the elastomer section 130 were to occur, the inner member 110 would be prevented from being removed from the outer cup 200 by the overlapping dimensions of the damping plate 140 and the collar 310. In this way, the additional load-bearing capacity enabled by the collar 310 allows the fluid mounts 100 and 102 to carry the required ROPS loads for a given vehicle configuration and/or cab structure. As a result, the ROPS capability of the mounts to be added or removed by selectively including collar 310. This allows the ROPS capability of these mounts to be truly modular by selectively incorporating this element into the mount configuration.

In addition, in the embodiments shown in FIGS. 1 and 2, a portion of the elastomer section 130 is radially precompressed to have an elastomer contour 134 that varies along a longitudinal axis of the elastomer section 130, and a corresponding portion of the outer cup 200 surrounding the precompressed portion of the elastomer section 130 is radially crimped to a decreased cup diameter D₁ to substantially follow the shape of the elastomer contour 134 and reinforce the radial precompression. In some embodiments, for example, the elastomer section 130 is precompressed by the action of crimping the corresponding portion of the outer cup 200. Alternatively, the elastomer section 130 can be precompressed directly by the process by which the crimping of the outer cup 200 is achieved. Regarding the manner in which the crimping is achieved, in some embodiments, a collet swage machine is used to radially crimp cup 200, which achieves large deformations in the outer cup 200 while minimizing distortion and wall thinning. Alternatively, in other embodiments, hydro-forming is used to crimp the outer cup 200. Roll forming is another method of crimping the outer cup 200, but it has the risk of thinning the cup wall and limiting the depth of the allowable deformation in the outer cup 200.

Regardless of the particular method used, the radially crimping of the outer cup 200 securely contains the bonded core within. In addition, the fluid mounts 100 and 102 exhibit increased durability from radially crimping the outer cup 200, since radially crimping the outer cup 200 both reinforces the radially precompression of the elastomer section 130 and radially crimps an inner surface of the outer cup 200 such that the elastomer contour 134 and the inner surface of the outer cup 200 have a substantially similar contour. In one aspect, as shown in FIGS. 3, 5, and 6, the elastomer contour 134 is formed with a diameter that varies from a point substantially below the flange 210 of outer cup 200 to a point on the elastomer contour 134 above the damping plate 140. The transitions on the elastomer contour 134 from one diameter to another can be substantially smooth. Therefore, when the outer cup 200 is crimped into the elastomer contour 134, the outer cup 200 mimics the elastomer contour 134 and is radially crimped in at least two places, such that a crimped area is formed that is substantially parallel with the longitudinal axis of the inner member 110. At the crimped area, the outer cup 200 has the narrowest diameter (e.g., crimped cup diameter D₁ illustrated in FIG. 6). Additionally, the outer cup 200 is crimped to mimic the elastomer contour 134, such that the external surface 240 of the outer cup 200 has a smooth transitional contour from the non-crimped areas of the outer cup 200 to the crimped area of the outer cup (and vice versa), in view of the smooth transitional elastomer contour 134. Alternatively, in some configurations, elastomer contour 134 has a more abrupt transitional profile, and thus when the outer cup 200 is crimped to mimic the elastomer contour 134, the external surface 240 of the outer cup 200 has a more abrupt transitional contour from the non-crimped areas of the outer cup 200 to the crimped area of the outer cup (and vice versa).

It is noted, however, that the substantial similarity of contours between the elastomer contour 134 and the inner surface of the outer cup 200 are not absolutely necessary due to the incompressible nature of elastomer section 130. For example, the crimp axial length may actually be longer than the axial length of the molded undercut, thereby axially stretching the elastomer at the interface. In any configuration, the relative motion at the interface between the elastomer contour 134 and the outer cup 200 are substantially minimized. A precompressed friction interface has been previously used for elastomeric mounts, but precompressed friction interface are not known to be used for elastomeric mounts used in fluid mounts, as disclosed herein.

Radial precompression of the elastomer section 130 further reduces relative motion, improves fatigue life, and provides superior sealing of the fluid mount 100 or 102 (e.g., by creating a beadles seal between the elastomer section 130 and the outer cup 200 to seal the viscous fluid F within the outer cup 200). The particular degree of precompression can be designed to provide the desired response in the elastomer section 130. In some configurations, for example, radial precompression of the elastomer section 130 ranges from approximately 5% of the original (i.e., uncompressed) elastomer section wall thickness to approximately 30% of original elastomer section wall thickness. In some particular examples, the percentage of radial precompression is between approximately 12% and 20% of the original elastomer wall thickness. That being said, those having skill in the art will recognize that the amount of precompression is adjustable to adapt fluid mount 100 or 102 to different desired static and/or snubbing load responses. In addition, by selecting the properties of the elastomer section 130 prior to manufacture, the 1G static load rating of the fluid mount 100 or 102 can be adjusted from its largest load rating to its smallest load rating (e.g., by adjusting the modulus of the elastomer section 130).

Furthermore, in some embodiments, a ring 120 is encapsulated or bonded within the elastomer section 130 and, in conjunction with the radially precompressed elastomer section 130, increases durability and damping of the fluid mounts 100 and 102. In particular, where the ring 120 is integrated within the elastomer contour 134, between approximately 12% and 20% radial precompression of the elastomer section 130 results in a significant reduction in relative motion at the interface, such that the axial position at the interface will not substantially change over time, which will result in an improved durability resulting from reduced wear at the interface. In other aspects, the fluid mounts 100 and 102 do not include the ring 120. Instead, these embodiments rely substantially on the radial crimp of the outer cup 200 and the elastomer section 130 and on the collar 310 to reduce relative motion at the crimped interface. In addition, in some configurations, the outer cup 200 stretches the elastomer contour 134 in the axial direction to minimize the relative motion at the interface. By integrating the ring 120 into the elastomer contour 134, however, the relative motion at the interface is diminished, thus providing even more increased durability of the fluid mounts 100 and 102. Similarly, a second ring (not shown) can be added above the elastomer contour 134 and provide a higher reduction in relative motion.

Further, radial precompression of the elastomer section 130 provides improved sealing of the viscous fluid F inside the fluid mounts 100 and 102. Traditionally, sealing a specified volume of viscous fluid within an interior of a fluid mount has been accomplished by using sealing beads incorporated into the outer contours of the elastomer. Maintaining the specified volume of viscous fluid within the fluid mount is desirable because of the damping accomplished by the viscous fluid and the damping plate acting in combination as a dashpot damper. Even small quantities of leakage of the viscous fluid impacts the efficiency and ability of the fluid mount to control and reduce gross vehicle cab movement and vibration. Therefore, radially precompressing the elastomer section 130 provides superior sealing of the broadband damping fluid mounts 100 and 102, as disclosed herein, because the elastomer section 130 is compressed to a higher percentage and over a larger area than traditional sealing beads typically allow. Radial precompression of between about 12% and 20% of the elastomer section 130 provides effective sealing, although radial precompression substantially between 5% and 30% can also be sufficient. The use of traditional sealing beads incorporated into the outer elastomer contour 134, in addition to radial precompression of the elastomer 130, provides for similar results. The radial precompression of the elastomer section 130 provides sealing even during use in low-temperature environments affecting the different materials' coefficient of thermal expansion. This approach creates a tight seal over a large area. In addition, in some embodiments, a vacuum is used during the assembly process to control the amount of negative or positive pressure in the assembled mount.

Furthermore, in combination with or in addition to the pull-out prevention provided by the collar 310, radially crimping the outer cup 200 provides an additional pull-out limiting effect that has safety benefits. When the outer cup 200 is radially crimped, the outer cup 200 has a smaller diameter at the crimped portion than the outer diameter of the damping plate 140 (e.g. FIG. 6). This acts as a safety precaution by preventing separation of the damping plate 140 from the outer cup 200, even if elastomeric failure were to occur. In addition, the positioning of the collar 310 about the elastomer section 130 reinforces this pull-out prevention. As shown in FIGS. 1 and 6, for example, the collar 310 can be positioned about the portion of the outer cup 200 that is crimped about the elastomer contour 134. In this configuration, the collar 310 acts to further reinforce the precompression of the elastomer section 130 at the elastomer contour 134 and to prevent deformation of the outer cup 200 by the damping plate 140 if the inner member 110 were subjected to a high upward axial load. In this way, the crimping of the outer cup 200 and the positioning of the collar 310 act together to prevent pull-out of the inner member 110. Alternatively, as shown in FIG. 2, the collar 310 can be positioned above the flange 210 of the outer cup 200. In this configuration, the crimped portion of the outer cup 200 provides a first barrier for the damper plate 140 to pass when the inner member 110 is subjected to a high upward axial load, but even if the crimped cup is unable to keep the damping plate 140 in place, the collar 310 provides a secondary level of pull-out prevention.

In each configuration of the fluid mounts 100 and 102, an upper portion of the inner member 110 is configured to be coupled to a top plate assembly 150, which provides a point of connection to a supporting structure, such as a cab of an off-highway vehicle. In particular, the inner member 110 is configured to receive a top plate fastener 152 (e.g. a bolt as illustrated in FIGS. 1 and 2). In one aspect shown in FIG. 3, for example, an upper blind threaded hole 112 longitudinally extends from a top surface of the inner member 110 towards a center of the inner member 110, for a specified depth, that varies based on the length, size and/or shape of the top plate fastener 152 being used. The dimensions of the blind threaded hole 112 are selected based on the parameters of a given application. When blind threaded hole 112 is a through hole and the fluid mount 100 or 102 is sealed, the diameter and/or depth of the blind threaded hole 112 is selectable so that the volume of air available within the fluid mount 100 or 102 can be increased or decreased. The dimensions of the blind threaded hole 112 are selected during manufacturing. As shown in FIG. 3, however, in some embodiments, the depth of the upper blind threaded hole 112 terminates at a partition 114 so that it does not connect with the lower blind threaded hole 116. In this way, the partition 114 helps to seal the viscous fluid F within the closed end of the outer cup 200, and is further operable to improve the rigidity of the inner member 110.

In addition to providing a load path between the top plate assembly 150 and the supporting frame structure 300, the fluid mounts 100 and 102 acts as a “dashpot” damper to remove energy of motion of the cab with respect to the frame. Specifically, the particular configurations of the fluid mounts 100 and 102 disclosed herein provide a “soft ride” operating zone designed to the natural frequency of the components of the mounts. Specifically, for example, in some embodiments, the materials and configurations of the inner member 110, the elastomer section 130, the ring 120 (if provided), the damper plate 140, and the viscous fluid F are selected based on a natural frequency range from about 8 Hz to about 10 Hz (e.g., having a nominal natural frequency of about 9 Hz).

Furthermore, the configurations of the fluid mounts 100 and 102 disclosed herein additionally provide a motion-controlling “snubbing” region in both the axial and radial directions to allow for limited cab movement with respect to the frame of the vehicle. As used herein, the term “snubbing” means reducing or stopping movement between fixed and movable portions of a vehicle (e.g., the frame and the cab) by absorbing kinetic energy therebetween by engaging stiffer elements after a certain deflection. In the configurations disclosed herein, for example, this engagement of stiffer elements is achieved via the elastomeric profile member of the vehicle mount devices described herein. Specifically, the elastomeric profile part can include snubbing surfaces for absorbing and/or dissipating kinetic energy. Thus, in some aspects, “snubbing” is a form of shock absorbing.

In the particular embodiments disclosed herein and illustrated in FIG. 6, for instance, the elastomeric profile 130 includes a first snubbing contact surface 132 (upward-facing surface in FIG. 6), a second snubbing contact surface 136 (downward-facing surface in FIG. 6), and a third snubbing surface that is positioned radially-inward on the elastomeric profile 130 (e.g., at elastomer contour 134). The first and second snubbing contact surfaces 132 and 136 are adapted to control axial downward and upward motion, respectively, and are customizable during manufacturing for adapting to application needs via altering the contact locations of the elastomeric profile 130. As used herein, customizable refers to the specific vehicle size, weight, use and ride characteristics desired by the customer.

In this configuration, where fluid mount 100 or 102 is secured to a top plate assembly 150 as shown in FIG. 6, after a certain downward deflection, top plate assembly 150 engages an upper portion of elastomer section 130 at the first snubbing contact surface 132, which results in an increase in the downward mount stiffness. Similarly, after a certain upward deflection, the damping plate 140 engages the bottom portion of the elastomer section 130 at the second snubbing contact surface 136, which results in an increase in the upward mount stiffness increases. In addition, in either event, the crimped cup 200 provides a surface (e.g., angled) that reacts the load in each of these upward and downward snubbing portions of the elastomer 130. Snubbing is beneficial in broadband fluid mounts used in cab mount applications because it helps to limit overall cab motion.

Further, in configurations in which at portion of the outer cup 200 is crimped about an elastomer contour 134 of the elastomer section 130, the decreased cup diameter D₁ resulting from radially crimping the outer cup 200 is also operable to react the downward and upward snubbing loads. Specifically, the wall of the crimped cup between the original cup diameter D₀ and the decreased cup diameter D₁ react with the snubbing load transmitted into the precompressed elastomer section 130 from the inner member 110 and snubbing elements.

The present subject matter can be embodied in other forms without departing from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

What is claimed is:

1. A damping fluid mount comprising:
an inner member;
an elastomer section that is affixed to an outer surface of the inner member;
an annular damping plate attached to a bottom portion of the inner member;
a cup containing viscous fluid positioned about the elastomer section and the damper plate; and
a collar positioned about a portion of the elastomer section, the collar having an inner diameter that is less than an outer diameter of the damper plate.

2. The damping fluid mount of claim 1, wherein a portion of the cup is radially crimped into a portion of the elastomer section, wherein the portion of the elastomer section is precompressed.

3. The damping fluid mount of claim 2, wherein radial precompression of the precompressed portion of the elastomer section ranges between about 5% and about 30% of an uncompressed thickness of the elastomer section.

4. The damping fluid mount of claim 3, wherein radial precompression of the precompressed portion of elastomer section is between about 12% and about 20% of the uncompressed thickness of the elastomer section.

5. The damping fluid mount of claim 2, wherein an outer diameter of the annular damping plate is greater than an inner diameter of the portion of the cup that is crimped.

6. The damping fluid mount of claim 2, wherein the collar is positioned about the portion of the cup that is crimped.

7. The damping fluid mount of claim 2, wherein the cup is positioned about a lower portion of the elastomer section and the damper plate, but an upper portion of the elastomer section is not contained within the cup; and
wherein the collar is positioned about the upper portion of the elastomer section.

8. The damping fluid mount of claim 2, further comprising a ring integrated within the elastomer contour and crimped to conform to the elastomer contour;
wherein a diameter of the ring is greater than an inner diameter of the crimped portion of the cup.

9. The damping fluid mount of claim 1, wherein the elastomer section comprises an elastomer material selected to have an elastic modulus corresponding to a desired 1G static load rating.

10. The damping fluid mount of claim 1, wherein the cup contains a ratio of viscous fluid and air corresponding to a desired load response at expected operating frequencies.

11. The damping fluid mount of claim 1, wherein the cup comprises a flange at an open end of the cup; and
wherein the collar is secured to the flange.

12. A damping fluid mount comprising:
an inner member;
an elastomer section that is affixed to an outer surface of the inner member;
an annular damping plate attached to a bottom portion of the inner member;
a cup containing viscous fluid positioned about the elastomer section and the damper plate, a portion of the cup being radially crimped into a precompressed portion of the elastomer section, and an inner diameter of the portion of the cup that is crimped being less than an outer diameter of the annular damping plate; and
a collar positioned about the portion of the cup that is crimped, the collar having an inner diameter that is less than the outer diameter of the damper plate.

13. A method for assembling a damping fluid mount comprising the steps of:
coupling an elastomer section to an outer surface of an inner member;
coupling a damping plate to a bottom portion of the inner member;
inserting the elastomer section coupled to the inner member and to the damping plate into a cup, wherein the cup contains a quantity of viscous fluid; and
positioning a collar about a portion of the elastomer section, the collar having an inner diameter that is less than an outer diameter of the damper plate.

14. The method for assembling the damping fluid mount of claim 13, comprising radially crimping a portion of the cup to form a crimped portion that extends into an elastomer contour disposed on an exterior surface of the elastomer section, wherein crimping the portion of the cup radially precompresses the elastomer section and decreases an inner diameter of the crimped portion of the cup.

15. The method for assembling the damping fluid mount of claim 14, wherein precompressing the elastomer section provides a radial precompression of the elastomer section having a range between about 5% and about 30% of an uncompressed thickness of the elastomer section.

16. The method for assembling the damping fluid mount of claim 15, wherein precompressing the elastomer section provides a radial precompression of the elastomer section having a range between of about 12% and about 20% of the uncompressed thickness of the elastomer section.

17. The method for assembling the damping fluid mount of claim 14, wherein positioning a collar about a portion of the elastomer section comprises positioning the collar about the crimped portion of the cup.

18. The method for assembling the damping fluid mount of claim 14, further comprising integrating a ring into the elastomer contour, wherein a diameter of the ring is greater than the inner diameter of the crimped portion of the cup.

19. The method for assembling the damping fluid mount of claim 13, wherein the cup comprises a flange at an open end of the cup; and
wherein positioning a collar about a portion of the elastomer section comprises securing the collar to the flange.

20. The method for assembling the damping fluid mount of claim 13, comprising:
coupling the inner member to a cab of a vehicle; and
coupling the collar to a frame of the vehicle.
